(19) United States
(12) Patent Application Publication
(10) Pub. No.: US 2009/0090696 A1
(43) Pub. Date: Apr. 9, 2009

(54) SLURRIES FOR POLISHING OXIDE AND NITRIDE WITH HIGH REMOVAL RATES

(75) Inventors: Daniela White, Oswego, IL (US); John Parker, Naperville, IL (US)

Correspondence Address: STEVEN WESEMAN;ASSOCIATE GENERAL COUNSEL, I.P., CABOT MICROELECTRONICS CORPORATION, 870 NORTH COMMONS DRIVE, AURORA, IL, 60504, US

(73) Assignee: Cabot Microelectronics Corporation, Aurora, IL (US)

(21) Appl. No.: 11/868,744

(22) Filed: Oct. 8, 2007

(51) Int. Cl. B44C 1/22; C09K 3/14

(52) U.S. Cl. 216/89; 252/79.1

(57) ABSTRACT

The invention provides a chemical-mechanical polishing composition comprising (a) an abrasive selected from the group consisting of alumina, ceria, titania, and zirconia, (b) a cationic copolymer comprising (A) a cationic monomer comprising a quaternary amino group and (B) a nonionic monomer, and (c) water. The invention also provides a method of polishing a substrate using the aforementioned polishing composition.

### BACKGROUND OF THE INVENTION

As a method for isolating elements of a semiconductor device, a great deal of attention is being directed towards a shallow trench isolation (STI) process. A typical STI process involves the steps of (i) growth of a pad of silicon dioxide over the surface of a silicon substrate, (ii) deposition of a layer of silicon nitride over the silicon dioxide pad, (iii) formation of a photoresist mask over the silicon nitride layer, (iv) etching of the silicon nitride layer and then the silicon substrate to prepare trenches in the silicon in accordance with the mask pattern, (v) filling of the trenches with silicon oxide by deposition of silicon dioxide over the substrate surface, (vi) chemical-mechanical planarization (CMP) of the overlying silicon dioxide to expose the underlying silicon nitride, and then (vii) CMP of the silicon nitride to remove the silicon nitride and to thereby provide a silicon substrate having isolated silicon dioxide-filled trenches thereon.

Chemical-mechanical polishing compositions have been developed having selectivity for either removal of silicon dioxide or silicon nitride. Polishing compositions having selectivity for silicon dioxide remove silicon dioxide at a greater rate than silicon nitride, and when overlying silicon dioxide is substantially removed to expose underlying silicon nitride to the polishing composition, the overall material removal rate drops, thereby allowing silicon nitride to act as a stopping layer. Typically, once the overlying silicon dioxide has been removed, a second polishing step using a polishing composition having selectivity for silicon nitride over silicon dioxide is employed to remove the silicon nitride layer, whereby the low polishing rate for silicon dioxide exhibited by such polishing composition minimizes the undesirable removal of silicon dioxide remaining in the trenches.

Typically, polishing compositions having selectivity for silicon dioxide or silicon nitride contain a polymeric component that binds with the surface of either silicon dioxide or silicon nitride, thus presenting a steric barrier to removal of the polymer-bound material by abrasive components of the polishing compositions. However, polymeric components either reduce or have no effect on the silicon dioxide removal rate, thereby effectively limiting silicon dioxide removal rates, and thus device throughput, achievable with polymer-containing polishing compositions. Current generation polishing compositions intended for STI processing are limited by both the removal rate achievable on silicon dioxide and the need to employ two separate polishing compositions, in two separate polishing steps, to remove the overlying silicon dioxide and then the silicon nitride layer. Thus, there remains a need in the art for polishing compositions and methods exhibiting increased removal rates for silicon dioxide and capability for single step removal of both silicon dioxide and silicon nitride.

### BRIEF SUMMARY OF THE INVENTION

The invention provides a chemical-mechanical polishing composition comprising (a) an abrasive selected from the group consisting of alumina, ceria, titania, zirconia, and combinations thereof, (b) a cationic copolymer comprising (A) a cationic monomer comprising a quaternary amino group and (B) a nonionic monomer, wherein the cationic copolymer has a molecular weight of about 5,000 to about 50,000, and (c) water.

The invention also provides a method of chemically-mechanically polishing a substrate, which method comprises (i) contacting a substrate with a polishing pad and a chemical-mechanical polishing composition comprising (a) an abrasive selected from the group consisting of alumina, ceria, titania, zirconia, and combinations thereof, (b) a cationic copolymer comprising (A) a cationic monomer comprising a quaternary amino group and (B) a nonionic monomer, wherein the cationic copolymer has a molecular weight of about 5,000 to about 50,000, and (c) water, and (ii) moving the polishing pad relative to the substrate with the chemical-mechanical polishing composition therebetween to abrade at least a portion of the substrate to polish the substrate.

### DETAILED DESCRIPTION OF THE INVENTION

The invention provides a chemical-mechanical polishing composition comprising, consisting essentially of, or consisting of (a) an abrasive selected from the group consisting of alumina, ceria, titania, zirconia, and combinations thereof, (b) a cationic copolymer comprising (A) a cationic monomer comprising a quaternary amino group and (B) a nonionic monomer, wherein the cationic copolymer has a molecular weight of about 5,000 to about 50,000, and (c) water.

The abrasive typically comprises, consists essentially of, or consists of a metal oxide selected from the group consisting of alumina, ceria, titania, zirconia, and combinations thereof. Preferably, the abrasive is titania or zirconia.

As is well known in the art, abrasive particles comprise, at the lowest level of structure, primary particles. Primary particles are formed by covalent bonds between atoms comprising the particles and are stable to all but the harshest conditions. At the next level of structure, primary particles can be associated into secondary particles, generally referred to as aggregates. Aggregate particles comprise primary particles and are bonded together by covalent bonds and electrostatic interactions, and typically are resistant to degradation by, e.g., mechanical energy inputs such as high-shear mixing. As used herein, particle size refers to the size of aggregate particles. The abrasive particles typically have an average particle size (e.g., average particle diameter) of about 20 nm to about 250 nm. Preferably, the abrasive particles have an average particle size of about 30 nm to about 200 nm (e.g., about 40 nm to about 150 nm, or about 50 nm to about 125 nm, or about 75 nm to about 100 nm). More preferably, the abrasive particles have an average particle size of about 50 nm to about 100 nm. In this regard, particle size refers to the diameter of the smallest sphere that encloses the particle.

The abrasive desirably is suspended in the polishing composition, more specifically in the water component of the polishing composition. When the abrasive is suspended in the polishing composition, the abrasive preferably is colloidally stable. The term colloid refers to the suspension of abrasive particles in the liquid carrier. Colloidal stability refers to the maintenance of that suspension over time. In the context of this invention, an abrasive is considered colloidally stable if, when the abrasive is placed into a 100 ml graduated cylinder and allowed to stand unagitated for a time of 2 hours, the difference between the concentration of particles in the bottom 50 ml of the graduated cylinder ([B] in terms of g/ml) and the concentration of particles in the top 50 ml of the graduated cylinder ([T] in terms of g/ml) divided by the initial concentration of particles in the abrasive composition ([C] in terms of g/ml) is less than or equal to 0.5 (i.e., {[B]−[T]}/[C]≦0.5). The value of [B]−[T]/[C] desirably is less than or equal to 0.3, and preferably is less than or equal to 0.1.

Any suitable amount of abrasive can be present in the polishing composition. Typically, about 0.01 wt. % or more abrasive can be present in the polishing composition (e.g., about 0.05 wt. % or more, or about 0.1 wt. % or more). The amount of abrasive in the polishing composition preferably will not exceed about 5 wt. %, and more preferably will not exceed about 2.5 wt. % (e.g., will not exceed about 1 wt. %). Even more preferably the abrasive will comprise about 0.1 wt. % to about 2.5 wt. % (e.g., about 0.5 wt. % to about 1 wt. %) of the polishing composition.

The polishing composition comprises a cationic copolymer comprising, consisting essentially of, or consisting of (A) a cationic monomer comprising a quaternary amino group and (B) a nonionic monomer. The cationic monomer comprising a quaternary amino group and the nonionic monomer can be any such suitable monomers, including two or more of each type of monomer. The cationic copolymer is obtained via the copolymerization of the cationic monomer(s) comprising quaternary amino group(s) and the nonionic monomer(s). The polishing composition can comprise more than one such cationic copolymer.

For example, the cationic monomer comprising a quaternary amino group can comprise acyclic quaternary amino groups or cyclic quaternary amino groups. Quaternary amino groups have four carbon atoms bonded to nitrogen with the nitrogen atom having a positive charge. Preferably, the cationic monomer has the general structure: CH₂═C(R¹)(Y) wherein R¹ is H or C₁ to C₃ alkyl, and wherein Y is —C(═O)O(CH₂)ₙN⁺R²R³R⁴R⁵X⁻ or —CH₂N⁺(R⁴R⁵)CH₂CH═CH₂X⁻ wherein R², R³, R⁴, and R⁵ are independently C₁ to C₃ alkyl or benzyl, X⁻ is an anion selected from the group consisting of chloride, bromide, iodide, sulfate, hydrogensulfate, hydroxide, or alkylsulfonate (e.g., methylsulfonate), and n is an integer of 1 to 5. More preferably, the cationic monomer is a [2-(methacryloyloxy)ethyl]trimethylammonium salt, [2-(methacryloyloxy)ethyl]dimethylbenzylammonium salt, or diallyldialkylammonium salt (e.g., diallyldimethylammonium salt).

It will be appreciated that copolymers formed from cationic monomers represented by CH₂═C(R¹)(Y) wherein Y represents —C(═O)O(CH₂)ₙN⁺R²R³R⁴R⁵X⁻ have a polymeric backbone comprising acyclic quaternary amino groups.

When Y represents —CH₂N⁺(R⁴R⁵)CH₂CH═CH₂X⁻ and R¹ is hydrogen in forming the cationic monomer CH₂═C(R¹)(Y), it will be appreciated that the Y group comprises a second ethylenic unsaturation which can further take part in the copolymerization reaction and can further (i) form part of the same polymer chain in a head-to-head configuration, (ii) form part of the same polymer chain in a head-to-tail configuration, (iii) form part of a different polymer chain, or (iv) remain unreacted. It will be understood that a cationic monomer having the structure CH₂═CHCH₂N⁺(R⁴R⁵)CH₂CH═CH₂X⁻ undergoes polymerization in a head-to-tail configuration via an intramolecular cyclization to form ring structures comprising cyclic quaternary amino groups incorporated into the polymer chain, wherein the ring structures are represented by the following formula:

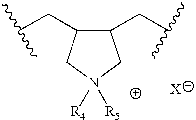

Non-limiting examples of suitable nonionic monomers include acrylamides, methacrylamides, and N-alkylacrylamides (e.g., N-methylacrylamide), and N,N-dialkylacrylamides (e.g., N,N-dimethylacrylamide). Preferably, the nonionic monomer is acrylamide or methacrylamide.

The ratio of cationic repeating unit to nonionic repeating unit in the cationic copolymer is not particularly limited, but preferably the cationic copolymer comprises about 20 mole % to about 90 mole % (e.g., about 40 mole % to about 80 mole %) of the cationic repeating unit and about 80 mole % to about 10 mole % (e.g., about 60 mole % to about 20 mole %) of the nonionic repeating unit.

The cationic copolymer typically has a molecular weight of about 5,000 or more (e.g., about 7,500 or more, or about 10,000 or more). Preferably, the cationic copolymer has a molecular weight of about 50,000 or less (e.g., about 45,000 or less, or about 40,000 or less). More preferably, the cationic copolymer has a molecular weight of about 10,000 to about 45,000 (e.g., about 15,000 to about 40,000). If the molecular weight of the cationic copolymer is too low, the cationic copolymer will have little influence on chemical-mechanical polishing using a polishing composition comprising the same. If the molecular weight of the cationic copolymer is too high, a polishing composition comprising the cationic copolymer may become colloidally instable.

The polishing composition can comprise any suitable amount of the cationic copolymer. Typically, the polishing composition comprises about 10 ppm or more (e.g., about 25 ppm or more, or about 50 ppm or more, or about 75 ppm or more) of the cationic copolymer. Preferably, the polishing composition comprises about 500 ppm or less (e.g., about 250 ppm or less, or about 125 ppm or less, or about 100 ppm or less) of the cationic copolymer. More preferably, the polishing composition comprises about 25 ppm to about 125 ppm (e.g., about 50 ppm to about 100 ppm) of the cationic copolymer.

The polishing composition comprises water. The water is used to facilitate the application of the abrasive particles, the cationic copolymer, and any other additives to the surface of a suitable substrate to be polished or planarized. Preferably, the water is deionized water.

The polishing composition can have any suitable pH. Typically, the polishing composition has a pH of about 3 to about 10 (e.g., about 4 to about 9). In a preferred embodiment, the polishing composition has a pH of about 3 to about 7 (e.g., about 4 to about 6). The polishing composition optionally comprises pH adjusting agents, for example, potassium hydroxide, ammonium hydroxide, alkylammonium hydroxides, and/or nitric acid. The polishing composition can optionally comprise pH buffering systems, for example, ammonium acetate or dipotassium hydrogen phosphate. Many such pH buffering systems are well known in the art.

The polishing composition optionally further comprises one or more other additives. Such additives include any suitable surfactant and/or rheological control agent. Suitable surfactants include, for example, cationic surfactants, anionic surfactants, anionic polyelectrolytes, nonionic surfactants, amphoteric surfactants, fluorinated surfactants, mixtures thereof, and the like.

The polishing composition optionally further comprises an antifoaming agent. The anti-foaming agent can be any suitable anti-foaming agent. Suitable antifoaming agents include, but are not limited to, silicon-based and acetylenic diol-based antifoaming agents. The amount of anti-foaming agent present in the polishing composition typically is about 40 ppm to about 140 ppm.

The polishing composition optionally further comprises a biocide. The biocide can be any suitable biocide, for example an isothiazolinone biocide. The amount of biocide present in the polishing composition typically is about 1 ppm to about 500 ppm, and preferably is about 10 ppm to about 200 ppm.

The polishing composition can be prepared by any suitable technique, many of which are known to those skilled in the art. The polishing composition can be prepared in a batch or continuous process. Generally, the polishing composition can be prepared by combining the components thereof in any order. The term “component” as used herein includes individual ingredients (e.g., abrasive, cationic copolymer, etc.) as well as any combination of ingredients (e.g., abrasive, cationic copolymer, buffering agent, etc.).

Any of the components used in conjunction with the invention can be provided in the form of a mixture or solution in water. Two or more components then desirably are individually stored and subsequently mixed to form the polishing composition. In this regard, it is suitable for the polishing composition to be prepared (e.g., for all the components to be mixed together) and then delivered to the surface of the substrate. It is also suitable for the polishing composition to be prepared on the surface of the substrate, through delivery of the components of the polishing composition from two or more distinct sources, whereby the components of the polishing composition meet at the surface of the substrate (e.g., at the point-of-use). In either case, the flow rate at which the components of the polishing composition are delivered to the surface of the substrate (i.e., the delivered amount of the particular components of the polishing composition) can be altered prior to the polishing process and/or during the polishing process, such that the polishing characteristics, such as the polishing rate, of the polishing composition is altered.

The polishing composition can be supplied as a one-package system comprising abrasive, cationic copolymer, and water. Alternatively, the abrasive and water can be supplied in a first container, and the cationic copolymer can be supplied in a second container, as a solution in water or as a pure substance. Optional components, such as an buffering agent, can be placed in the first and/or second containers or a third container. Furthermore, the components in a first container can be in dry form while the components in a second container can be in the form of an aqueous dispersion or solution. Moreover, the components in the first or second containers can have different pH values, or alternatively substantially similar, or even equal, pH values. Other two-container, or three or more container, combinations of the components of the polishing composition are within the knowledge of one of ordinary skill in the art.

The polishing composition also can be provided as a concentrate which is intended to be diluted with an appropriate amount of water prior to use. In such an embodiment, the polishing composition concentrate can comprise an abrasive, cationic copolymer, and water in amounts such that, upon dilution of the concentrate with an appropriate amount of water, each component of the polishing composition will be present in the polishing composition in an amount within the appropriate range recited above for each component. For example, the abrasive and cationic copolymer can each be present in the concentrate in an amount that is about 2 times (e.g., about 3 times, about 4 times, or about 5 times) greater than the concentration recited above for each component so that, when the concentrate is diluted with an equal volume of water (e.g., 2 equal volumes water, 3 equal volumes of water, or 4 equal volumes of water, respectively), each component will be present in the polishing composition in an amount within the ranges set forth above for each component. Furthermore, as will be understood by those of ordinary skill in the art, the concentrate can contain an appropriate fraction of the water present in the final polishing composition in order to ensure that the cationic copolymer and other suitable additives are at least partially or fully dissolved in the concentrate.

The invention also provides a method of chemically-mechanically polishing a substrate. The method comprises (i) contacting a substrate with a polishing pad and the polishing composition described herein, and (ii) moving the polishing pad relative to the substrate with the chemical-mechanical polishing composition therebetween to abrade at least a portion of the substrate to polish the substrate.

The method of the invention can be used to polish any suitable substrate, and is especially useful for polishing substrates comprising silicon dioxide and silicon nitride. Suitable substrates include wafers used in the semiconductor industry. The polishing composition is particularly well-suited for planarizing or polishing a substrate that has undergone shallow trench isolation (STI) processing. STI processing typically involves providing a silicon substrate on which is deposited a layer of silicon nitride. Trenches are etched onto a substrate comprising an overlying layer of silicon nitride following photolithography, and an excess of silicon dioxide is deposited thereon. The substrate is then subjected to planarization until the excess silicon dioxide and the surface layer of silicon nitride are substantially removed, such that the silicon oxide remaining in the trenches is approximately level with the edges of the trenches, with adjacent trenches insulated from each other by the intervening silicon of the substrate.

In accordance with the invention, the substrate can be polished with the polishing composition described herein by any suitable technique. The method of the invention is particularly well-suited for use in conjunction with a chemical-mechanical polishing (CMP) apparatus. Typically, the apparatus comprises a platen, which, when in use, is in motion and has a velocity that results from orbital, linear, or circular motion, a polishing pad in contact with the platen and moving with the platen when in motion, and a carrier that holds a substrate to be polished by contacting and moving the substrate relative to the surface of the polishing pad. The polishing of the substrate takes place by the substrate being placed in contact with the polishing pad, and moving the polishing pad relative to the substrate with the polishing composition therebetween, so as to abrade and remove a portion of the substrate and thereby polish at least a portion of the substrate.

The inventive method desirably allows for reasonable removal rates for both silicon dioxide and silicon nitride with relatively low levels of abrasive and the elimination of the necessity of separate polishing steps to remove silicon dioxide and silicon nitride, thereby permitting increased throughput of substrate processing.

A substrate can be planarized or polished with the chemical-mechanical polishing composition with any suitable polishing pad (e.g., polishing surface). Suitable polishing pads include, for example, woven and non-woven polishing pads. Moreover, suitable polishing pads can comprise any suitable polymer of varying density, hardness, thickness, compressibility, ability to rebound upon compression, and compression modulus. Suitable polymers include, for example, polyvinylchloride, polyvinylfluoride, nylon, fluorocarbon, polycarbonate, polyester, polyacrylate, polyether, polyethylene, polyamide, polyurethane, polystyrene, polypropylene, coformed products thereof, and mixtures thereof.

Desirably, the CMP apparatus further comprises an in situ polishing endpoint detection system, many of which are known in the art. Techniques for inspecting and monitoring the polishing process by analyzing light or other radiation reflected from a surface of the workpiece are known in the art. Such methods are described, for example, in U.S. Pat. No. 5,196,353, U.S. Pat. No. 5,433,651, U.S. Pat. No. 5,609,511, U.S. Pat. No. 5,643,046, U.S. Pat. No. 5,658,183, U.S. Pat. No. 5,730,642, U.S. Pat. No. 5,838,447, U.S. Pat. No. 5,872,633, U.S. Pat. No. 5,893,796, U.S. Pat. No. 5,949,927, and U.S. Pat. No. 5,964,643. Desirably, the inspection or monitoring of the progress of the polishing process with respect to a workpiece being polished enables the determination of the polishing end-point, i.e., the determination of when to terminate the polishing process with respect to a particular workpiece.

The following examples further illustrate the invention but, of course, should not be construed as in any way limiting its scope.

In the examples below, the polishing experiments generally involved the use of 21.4 kPa (3.1 psi) downforce pressure of the substrate against the polishing pad, 90 rpm platen speed, 93 rpm carrier speed, 180 mL/min polishing composition flow rate, and in-situ conditioning of a concentric grooved CMP pad.

### EXAMPLE 1

This example shows the effect of a cationic copolymer in accordance with the invention on removal rates for a silicon dioxide layer observed with the polishing composition of the invention.

Two different polishing compositions were used to separately chemically-mechanically polish similar silicon dioxide layers (Compositions 1A and 1B). Each of the compositions comprised 0.1 wt. % of titanium dioxide abrasive particles in water at a pH of 4. Composition 1A (control) contained no further ingredients (e.g., no cationic copolymer). Composition 1B (invention) additionally contained 50 ppm of poly(acrylamide-co-[2-(methacryloyloxy)ethyl]trimethylammonium)chloride (i.e., a cationic copolymer). Following use of the polishing compositions, the silicon dioxide (“oxide”) removal rates were determined. The results are set forth in Table 1.

TABLE 1

| Polishing Composition | Oxide Removal Rate (Å/min) |
|---|---|
| 1A (control) | 220 |
| 1B (invention) | 910 |

As is apparent from the results set forth in Table 1, the inventive polishing composition comprising 50 ppm of a cationic copolymer exhibited a silicon dioxide removal rate that was approximately 4.1 times the removal rate exhibited by the control polishing composition.

### EXAMPLE 2

This example shows the effect of a cationic copolymer in accordance with the invention on removal rates for silicon dioxide and silicon nitride layers observed with the polishing composition of the invention.

Ten different polishing compositions were used to separately chemically-mechanically polish similar silicon nitride and silicon dioxide layers (Compositions 2A-2J). Each of the compositions comprised zirconia at a pH of 4 in water. Compositions 2A-2E each contained 0.5 wt. % of zirconia, and Compositions 2F-2J each contained 1 wt. % of zirconia. Compositions 2A and 2F (control) contained no further ingredients (e.g., no cationic copolymer). Compositions 2B and 2G (invention) additionally contained 75 ppm of a [2-(methacryloyloxy)ethyl]ethyltrimethylammonium chloride/acrylamide copolymer (i.e., a cationic copolymer) having a ratio of [2-(methacryloyloxy)ethyl]trimethylammonium chloride monomers to acrylamide monomers of 3:1. Compositions 2C and 2H (comparative) additionally contained 75 ppm of poly([2-(methacryloyloxy)ethyl]ethyltrimethylammonium chloride) (i.e., a cationic homopolymer). Compositions 2D and 21 (comparative) additionally contained 75 ppm of poly(diallyldimethylammonium chloride) (i.e., a cationic homopolymer). Compositions 2E and 2J (comparative) additionally contained 75 ppm of poly(acrylic acid-diallyldimethylammonium chloride) (i.e., an amphoteric copolymer). Following use of the polishing compositions, the silicon dioxide (“oxide”) and silicon nitride (“nitride”) removal rates were determined. The results are set forth in Table 2.

TABLE 2

| | Oxide Removal | |
|---|---|---|
| Polishing Composition | Rate (Å/min) | Nitride Removal Rate (Å/min) |
| 2A (control) | 910 | 620 |
| 2B (invention) | 1220 | 1220 |
| 2C (comparative) | 680 | 860 |
| 2D (comparative) | 500 | 520 |
| 2E (comparative) | 830 | 640 |
| 2F (control) | 1460 | 920 |
| 2G (invention) | 1820 | 1400 |
| 2H (comparative) | 880 | 1240 |
| 2I (comparative) | 700 | 800 |
| 2J (comparative) | 1320 | 1240 |

As is apparent from the results set forth in Table 2, the presence of a cationic copolymer in Composition 2B containing 0.5 wt. % zirconia resulted in an oxide removal rate increase of approximately 34% and a nitride removal rate increase of approximately 97% as compared to the control polishing composition. The presence of a cationic copolymer in Composition 2G containing 1 wt. % zirconia resulted in an oxide removal rate increase of approximately 25% and a nitride removal rate increase of approximately 52% as compared to the control polishing composition. In contrast, the presence of the cationic homopolymer poly([2-(methacryloyloxy)ethyl]ethyltrimethylammonium chloride) in Compositions 2C and 2H resulted in a suppression of the oxide removal rate and an increase in the nitride removal rate as compared to the control polishing composition. The presence of the cationic homopolymer poly(diallyldimethylammonium chloride) in Compositions 2D and 2I resulted in a suppression of both the oxide removal rate and the nitride removal rate as compared to the control polishing composition. The presence of an amphoteric copolymer in Compositions 2E and 2J resulted in suppression of the oxide removal rate and an increase in the nitride removal rate as compared to the control polishing composition.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A chemical-mechanical polishing composition comprising:
(a) an abrasive selected from the group consisting of alumina, ceria, titania, zirconia, and combinations thereof,
(b) a cationic copolymer comprising (A) a cationic monomer comprising a quaternary amino group and (B) a nonionic monomer, wherein the cationic copolymer has a molecular weight of about 5,000 to about 50,000, and
(c) water.

2. The polishing composition of claim 1, wherein the polishing composition comprises about 0.1 wt. % to about 2.5 wt. % of abrasive.

3. The polishing composition of claim 1, wherein the abrasive is titania or zirconia.

4. The polishing composition of claim 1, wherein the cationic monomer comprises an acyclic quaternary amino group.

5. The polishing composition of claim 4, wherein the cationic monomer is a [2-(methacryloyloxy)ethyl]trimethylammonium salt or a [2-(methacryloyloxy)ethyl]dimethylbenzylammonium salt.

6. The polishing composition of claim 1, wherein the nonionic monomer comprises an acrylamide unit.

7. The polishing composition of claim 1, wherein the cationic monomer comprises a cyclic quaternary amino group.

8. The polishing composition of claim 1, wherein the cationic copolymer has a molecular weight of about 10,000 to about 45,000.

9. The polishing composition of claim 1, wherein the cationic copolymer is present in an amount of about 50 ppm to about 100 ppm.

10. A method of chemically-mechanically polishing a substrate, which method comprises:
(i) contacting a substrate with a polishing pad and a chemical-mechanical polishing composition comprising:
(a) an abrasive selected from the group consisting of alumina, ceria, titania, zirconia, and combinations thereof,
(b) a cationic copolymer comprising (A) a cationic monomer comprising a quaternary amino group and (B) a nonionic monomer, and
(c) water, wherein the cationic copolymer has a molecular weight of about 5,000 to about 50,000, and
(ii) moving the polishing pad relative to the substrate with the chemical-mechanical polishing composition therebetween to abrade at least a portion of the substrate to polish the substrate.

11. The method of claim 10, wherein the polishing composition comprises about 0.1 wt. % to about 2.5 wt. % of abrasive.

12. The method of claim 10, wherein the abrasive is titania or zirconia.

13. The method of claim 10, wherein the cationic monomer comprises an acyclic quaternary amino group.

14. The method of claim 13, wherein the cationic monomer is a [2-(methacryloyloxy)ethyl]trimethylammonium salt or a [2-(methacryloyloxy)ethyl]dimethylbenzylammonium salt.

15. The method of claim 10, wherein the nonionic monomer comprises an acrylamide unit.

16. The method of claim 10, wherein the cationic monomer comprises a cyclic quaternary amino group.

17. The polishing composition of claim 10, wherein the cationic copolymer has a molecular weight of about 10,000 to about 45,000.

18. The method of claim 10, wherein the cationic copolymer is present in an amount of about 50 ppm to about 100 ppm.

19. The method of claim 10, wherein the substrate comprises at least one layer comprising silicon dioxide, and at least a portion of the silicon dioxide is abraded to polish the substrate.

20. The method of claim 19, wherein the substrate further comprises at least one layer comprising silicon nitride, and at least a portion of the silicon nitride is abraded to polish the substrate.
